(19) United States
(12) Patent Application Publication
(10) Pub. No.: US 2026/0331825 A1
(43) Pub. Date: Oct. 22, 2026

(54) CHARGING CONTACTS

(71) Applicant: Menashe OZ, Rehovot (IL)

(72) Inventor: Menashe OZ, Rehovot (IL)

(21) Appl. No.: 19/052,615

(22) PCT Filed: Aug. 14, 2023
(86) PCT No.: PCT/IL2023/050847

§ 371 Date: Feb. 13, 2025

(30) Foreign Application Priority Data
Aug. 15, 2022 (IL) 295655

(51) Int. Cl. H01R 13/62; H01R 13/22

(52) U.S. Cl. CPC H01R 13/6205; H01R 13/22

(57) ABSTRACT

An electrical power charging contacts including, a female charge contact(s) assembly having one or more female conductive contact member and a first base plate connected to one or more female conductive contact member having one or more female conductive contact. Amale collector charge contact(s) assembly having one or more male extendable conductive contact member having one or more male conductive contact, a conductive contact shaft having a magnet ring housing. The male collector charge contact(s) assembly further includes a second base plate having one or more holes where the one or more male extendable conductive contact member is extendable there from. Each of the male extendable conductive contact member is extendable from the second plate independently and moveable in all directions. Each of the male and female conductive contact is provided with attraction force that attracts the male and female conductive contact members when the female conductive contact is in proximity with the male conductive contact.

### RELATED APPLICATION

This application claims priority to Isreal Patent Application No. 295655, filed Aug. 15, 2022, and PCT Application No. PCT/IL2023/050847, filed Aug. 14, 2023, both entitled CHARGING CONTACTS, by Menashe Oz, the contents of which are incorporated herein by reference.

### FIELD OF THE INVENTION

The present invention relates to systems and methods for recharging rechargeable batteries of electric charge object. More particular the present invention relates to conductive charging contacts.

### BACKGROUND OF THE INVENTION

Conductive charging using contacts instead of wires, sometimes called conductive wireless charging, is conductive power transfer that replaces the conductive wires between the charger and the charged device with conductive contacts.

U.S. Pat. No. 10,566,734 discloses a system for facilitating electrical connection of a first electrical unit included in a first object with a second electrical unit included in a second object is disclosed. The system may include a base unit configured to be attached to the first object. Further, the base unit may include a base body and a base conductive pad disposed in a mid-region of the base body. Further, the system may include a first magnet, a second magnet and a third magnet disposed in the base body. Further, the system may include a holder unit configured to be attached to the second object, including a holder body. Further, the system may include a holder magnet disposed in the holder body. Further, the holder unit may include a moving guide, including a guide body, and a guide conductive pad.

Further, the moving guide may include a guide magnet disposed in the guide body. The holder may be mounted on a mobile device that travels over the base unit. In one position the magnets act to repel movement of the moving guide. In another position the magnets act to attract the moving guide towards the base unit to cause electrical connection between the conductive pads.

EP2533374 describes a connector assembly for electrically connecting a first electrical or electronic item to a second electrical or electronic item, comprising a first connector having a first magnetic assembly with at least one magnetic element and having at least two contacts of an electrically conductive material, electrically connected to one of the first and second electrical or electronic items and electrically insulated from each other, and a second connector having a second magnetic assembly with at least one magnetic element and having at least two contacts of an electrically conductive material, electrically connected to the other of the first and second electrical or electronic items and electrically insulated to each other, wherein the contacts of the first connector are maintained in electrically conductive relationship with the contacts of the second connector by magnetic attraction between the first magnetic assembly and second magnetic assembly.

U.S. Pat. No. 9,130,291 describes a device connector includes a first electronic device magnet, second electronic device magnet, and third electronic device magnet to connect to a power supply. The power supply magnet can be oriented to the opposite pole of one of the electronic device magnets.

One of the objects of the present invention is to provide conductive charging using contacts that can be attracted to one another when they are positioned perpendicular to a plane such as but not limited to a floor.

Yet another object of the present invention is to provide conductive charging contacts even when the charging contacts are not perfectly aligned to one another.

Yet another object of the present invention is to provide electrical power charging contacts which the charging connection is reliable.

Yet another object of the present invention is to provide electrical power charging contacts that can be installed on chargeable objects. Where the chargeable objects can be coupled to one another in a stacked arrangement and charged at the same time with the same power charger such that each of the rechargeable objects is charged reliably.

Yet another object of the present invention is to increase the percentage of cases where there will be a successful charging even when male and female conductive contacts are not perfectly aligned to one another.

### SUMMARY OF THE INVENTION

The present invention relates to systems and methods for recharging batteries of electric charge objects. More particular the present invention relates to charging contacts.

In accordance with an embodiment of the present invention, there is provided an electrical power charging contact(s) including a female charge contact(s) assembly having at least one female conductive contact member and a first base plate connected to the at least one female conductive contact member having a female conductive contact. A male collector charge contact(s) assembly having at least one male extendable conductive contact member having a male conductive contact and a second base plate having at least one hole where the at least one male extendable conductive contact member is extendable therefrom. the at least one male extendable conductive contact member is extendable from the second plate independently and moveable in all directions. The at least one male and female conductive contact is provided with attraction force that attracts the male and female conductive contact members when the male conductive contact is in proximity with the female conductive contact.

### BRIEF DESCRIPTION OF THE DRAWINGS

The invention may be understood upon reading of the following detailed description of non-limiting exemplary embodiments thereof, with reference to the following drawings, in which:

FIG. 1 is a perspective front view of the electrical power charging contacts in accordance with some embodiments of the present invention where the male extendable contacts are in a retracted position;

FIG. 2 is a perspective front view of the electrical power charging contacts in accordance with some embodiments of the present invention where the male extendable contacts are shown in the extended position;

FIG. 3 is a perspective front view of the charge contacts base assembly in accordance with some embodiments of the present invention;

FIG. 4 is a perspective front view of the male collector charge contacts assembly in accordance with some embodiments of the present invention;

FIG. 5 is an exploded perspective rear view of the female contact in accordance with some embodiments of the present invention;

FIG. 6A is a rear view of the female contact in accordance with some embodiments of the present invention;

FIG. 6B is a sectional side view of the female contact shown in FIG. 6A;

FIG. 7 is a perspective rear view of the female charge contacts assembly in accordance with some embodiments of the present invention;

FIG. 8 is a perspective exploded rear view of the female charge contacts assembly in accordance with some embodiments of the present invention;

FIG. 9 is a perspective exploded front view of the female charge contacts assembly in accordance with some embodiments of the present invention;

FIG. 10 is an exploded perspective view of a male extendable contact member in accordance with some embodiments of the present invention;

FIG. 11 is a perspective view of the male extendable contact shaft interacts with a female contact member;

FIG. 12A is a perspective front view of the male extendable contact member in accordance with some embodiments of the present invention;

FIG. 12B is a perspective rear view of the male extendable contact member in accordance with some embodiments of the present invention;

FIG. 12C is a perspective side view of the male extendable contact member in accordance with some embodiments of the present invention;

FIG. 12D is a perspective sectional side view of the male extendable contact member in accordance with some embodiments of the present invention;

FIG. 13 is a perspective front view of stacked shopping carts in accordance with some embodiments of the present invention;

FIG. 14 is a perspective rear view of stacked chargeable shopping carts in accordance with some embodiments of the present invention; and

FIG. 15 is a schematic block diagram of an electrical power management system for stacked electrical power conductive charging systems in accordance with some embodiments of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

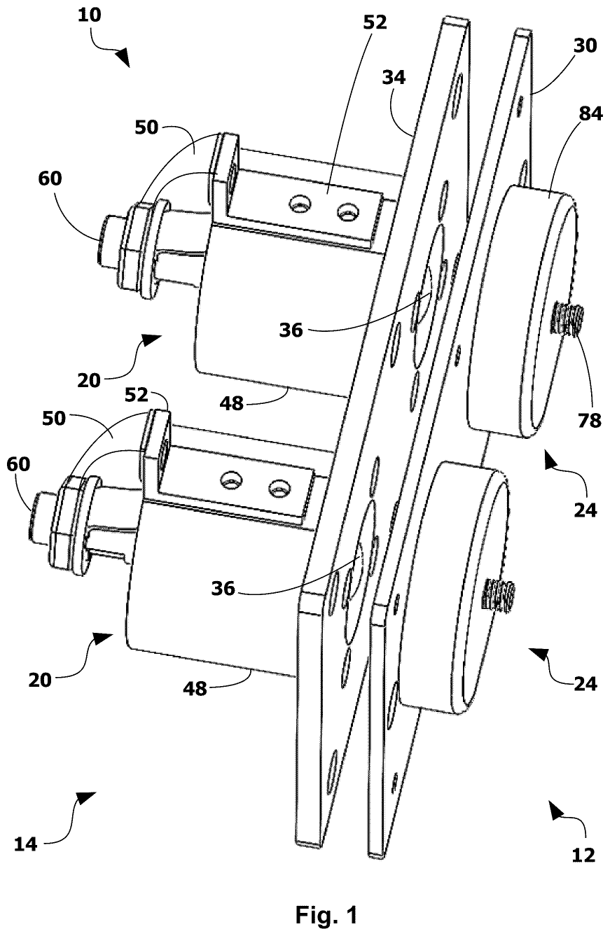

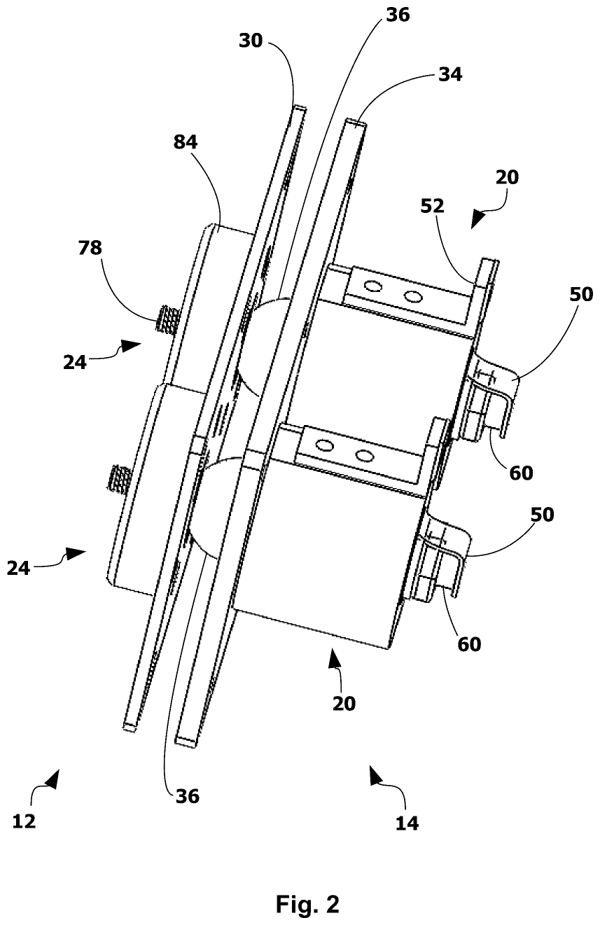

Referring first to FIG. 1 and FIG. 2 there is shown, an electrical power charging contact system 10 including a female charge contacts assembly 12 and a male collector charge contacts assembly 14. The female charge contacts assembly 12 of the invention can be installed on a floor, a wall, a ceiling or on any other plane and can be also installed on any electric charge object such as but not limited to electric devices, robots that can operate autonomously or non-autonomously, electric apparatuses, vehicles which can be electric or not electric that can operate autonomously or non-autonomously. The male collector charge contacts assembly 14 can be installed on any electric charge object such as but not limited to any chargeable devices, apparatuses, vehicles, or robots that can be autonomously or non-autonomously. For example, the charging contact system of the invention 10 can be installed on automatic guided vehicles (AGVs), also called autonomous mobile robot (AMR), which is a portable robot that follows along marked long lines or wires on the floor, or uses radio waves, vision cameras, magnets, or lasers for navigation. The charging system of the invention can also be installed for example on automatic guided carts (AGCs). The charging system of the invention can also for example be installed on smart shopping carts having a rechargeable battery to provide power to the electrical components that consume electric power in the shopping cart such as but not limited to monitor, controller, computer, motors etc.

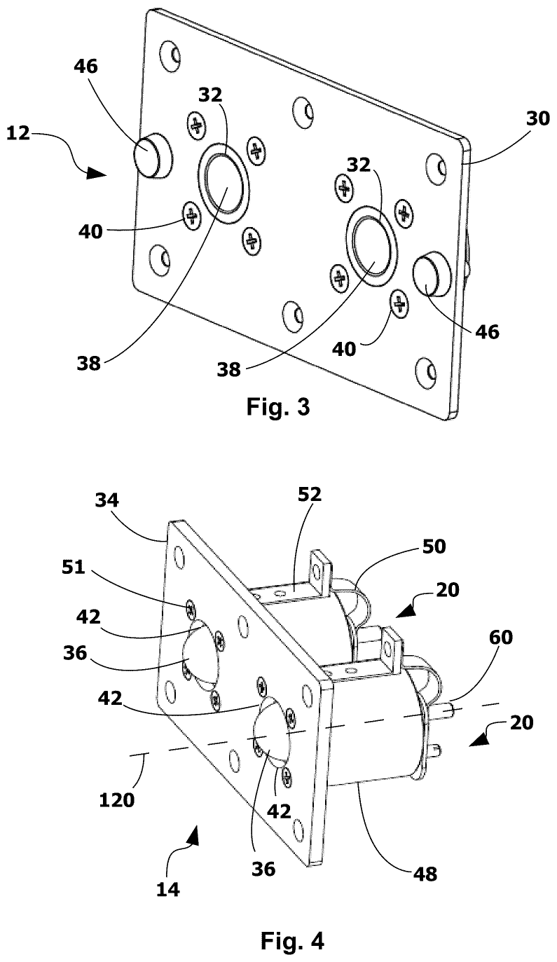

Referring also to FIG. 3 and FIG. 4, the male collector charge contacts assembly 14 includes two male extendable conductive contact members 20. The female charge contacts assembly 12 includes two female conductive contacts members 24. It should be noted that in some embodiments of the present invention the male collector charge contacts assembly 14 and the female charge contacts assembly 12 may include in some embodiments one or more members 20 and 24 respectively. The female contacts members 24 are assembled to base plate 30 and the male contacts members 24 are assembled to base plate 34. The female contacts members 24 include female conductive contacts 38. Male extendable contacts members 20 include male conductive contacts 36. The male extendable contact members 20 further include male conductive contact shaft 60, which will be described later in more detail.

Base plate 30 has two openings 32 where the two female conductive contacts 38 are affixed to the openings 32 by a fixing means such as but not limited to screws 40. Preferably, the female conductive contacts 38 have a concaved surface shape and the male extendable contacts 36 front portion have a convex surface shape. Female conductive contacts 38 and the extendable conductive male contact 36 are magnetized by magnets of opposite magnetic poles (north and south magnetic poles) for allowing them to attract to one another when they are in proximity to one another. The magnetic properties of the conductive contacts 38, 36 and their shapes create a magnetic ball-like joint whereas the extendable conductive male contact 36 may have a limited range of movement in all directions.

Base plate 34 has two openings 42 where the two extendable male conductive contacts 36 are capable to extend out from the openings 42 respectively and independently when male conductive contacts 36 are magnetically attracted to conductive contacts 38. The male conductive contacts 36 may have a limited range of movement in all directions as will be described later in more detail. Referring for example to FIG. 3 base plate 30 and/or base plate 34 may further include a shock absorbing means such but not limited to a rubber member 46 that absorbs the impact between the two plates 34 and 30 at the time where the conductive contacts 36 and 38 are attracted to one another and keep the plates in a small distance from each other when the male and female conductive contacts 36 and 38 are attracted.

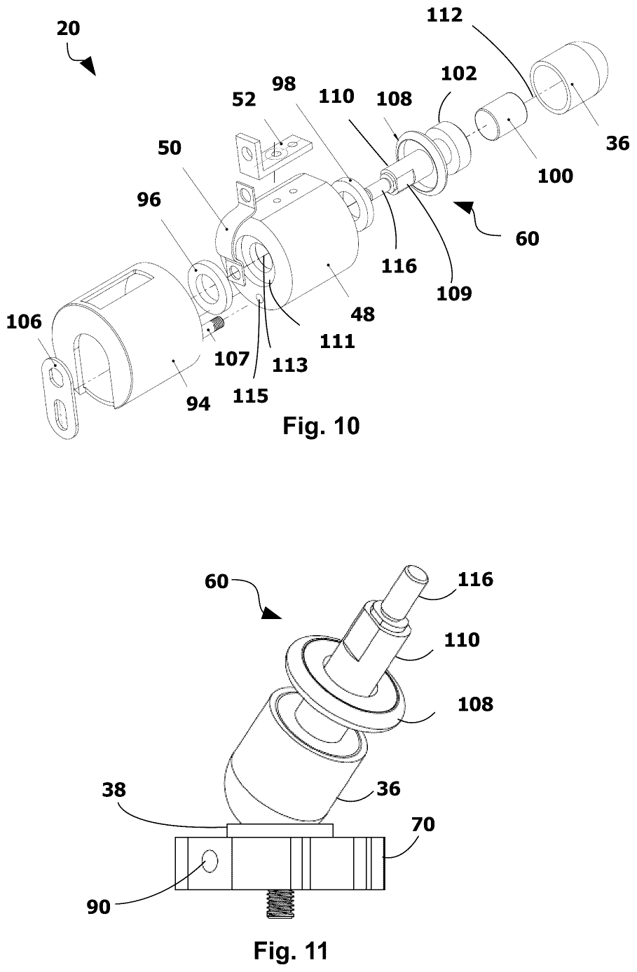

Referring also to FIG. 10, male extendable contact members 20 further include a hollow cylinder 48 connected perpendicular to the second plate 34 and centrally aligned to said plate holes 42. Member 20 further includes flexible copper braided cable 50 connected in one end to a fixed electrical contact 52 that is fixed to the bottom portion of cylinder 48, the other end of the flexible copper braided cable 50 is connected to the backend portion of the shaft 60. The upper portion of cylinder 48 is affixed to plate 34 for example by screws 51.

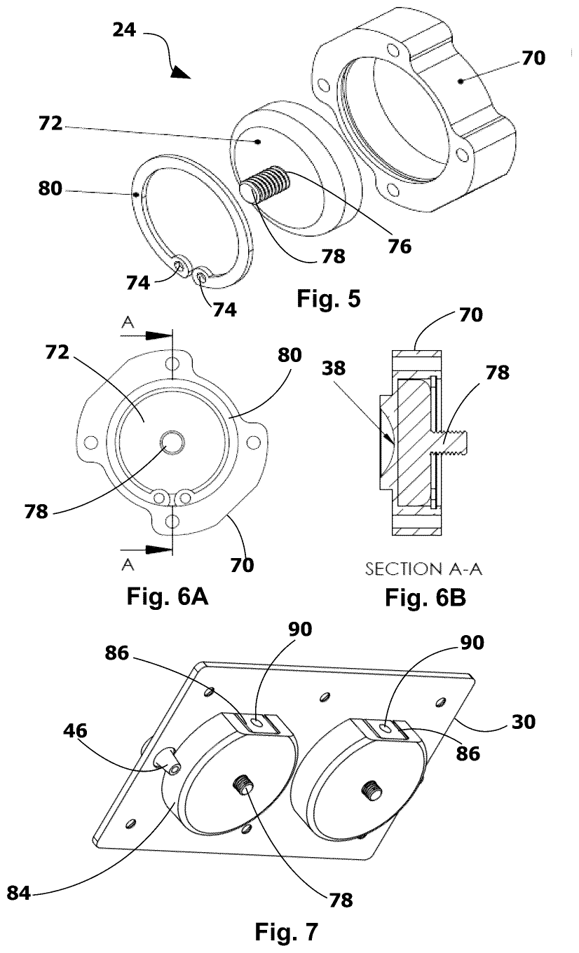

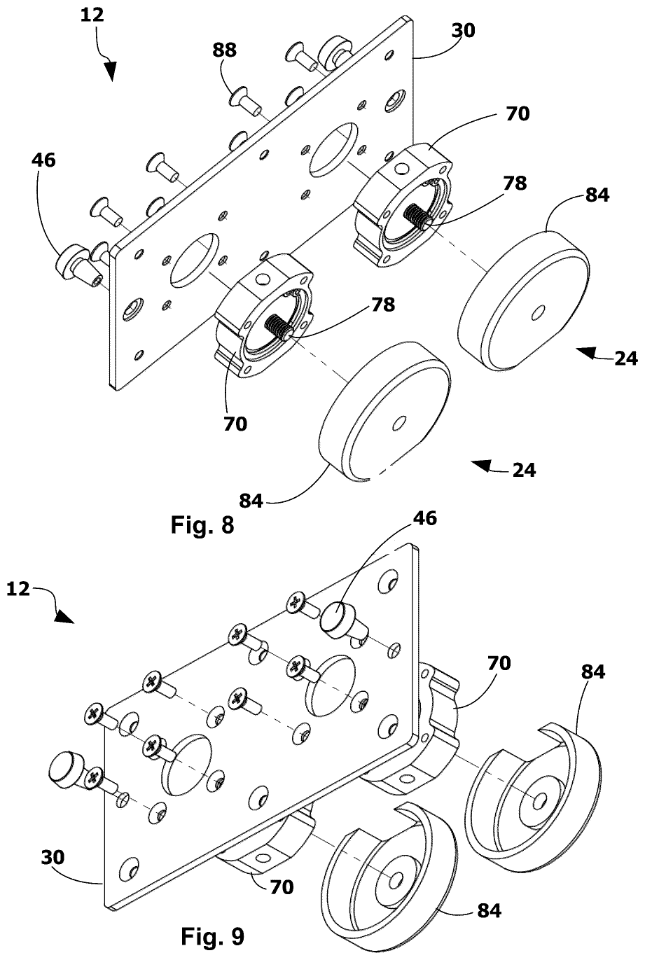

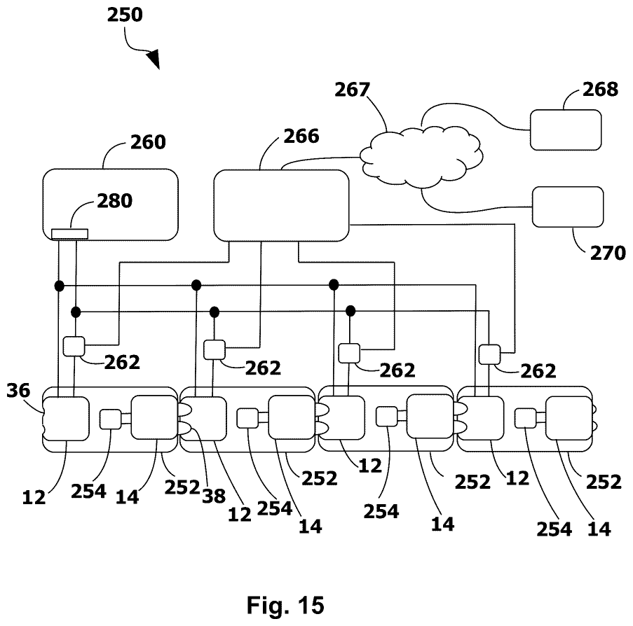

Referring to FIG. 5 to FIG. 9, the two female contact members 24 further include in this example two magnet holders 70 and two female contacts magnets 72. The holders 70 are provided for holding the magnets 72 and holding the female conductive contacts 38. The magnets 72 may have a hole 76 in the middle where a threaded rode 78 can be inserted thereto for stacking one or more magnets or thicker magnet 72. In the end portion of the threaded rode 78 a non-conductive nut, not shown, is used for attaching the magnet holder housing 84 to magnet holder 70. A lock ring 80 is installed on the holder 70 edge portion for preventing the magnets 72 from being removed from the holder 70 unintentionally. By applying pressure on the lock ring 80 utilizing holes 74 the lock ring 80 can be removed from the magnet holders 70 and then magnets 72 can be inserted or removed to/from magnet holders 70. The two female contact members 24 further include nonconductive magnet holder housing 84 for wrapping the holders 70 with nonconductive material for preventing shortcut between the holders for example if for example a conductive object may touch both magnet holders 70. The magnet holder housing 84 can be made of but not limited to a rubber or a composite material such as but not limited to FR-4 composed of woven fiberglass cloth with an epoxy resin binder that is flame resistant. The holder housing 84 has at least one opening 86 for connecting electrical wires in one end to electrical contact 90 and in the other end to power battery charger outlet 280 (shown in FIG. 15). Multiple screws 88 are provided for fixing the holder 70 to the base plate 30. Other suitable methods for fixing the holder 70 to base plate 30 can be used.

Referring to FIG. 10 there is shown components of the male extendable contact member 20 in an exploded view. Member 20 includes nonconductive cylinder housing 94, ring magnets 96 and 98, a cylinder magnet 100 the shaft 60, the extendable conductive male contact 36, the hollow cylinder 48, two holes flat plate 106, rod 107 and recess 115 are used as a stopper that prevents the shaft 60 to roll around axis 112 without limiting the shaft 60 to move limited movements in all directions. The stopper is used to prevent the flexible copper braided cable 50 to roll and damage the cable. shaft 60 includes male contact cover 102 positioned in the upper portion of shaft 60. The nonconductive cylinder housing 94 is used for preventing unintentional shortcut between the two conductive hollow cylinder 48 for example by a conductive object. The shaft 60 further includes magnet ring housing 108 connected to a cylindrical element 110 having a D-type cut 109 in its bottom portion. Ring housing 108 that houses magnet ring 98 have a rounded edge, shown for example in FIG. 11. The rounded edge housing 108 allowing shaft 60 to pivotally move inside the hollow cylinder 48 in all directions with a limited angle between the shaft 60 and the central axis of opening that is designated for example in FIG. 4 by a dashed line 120. The limited angle can be increased if for example during manufacturing, increasing the diameter of hole 113.

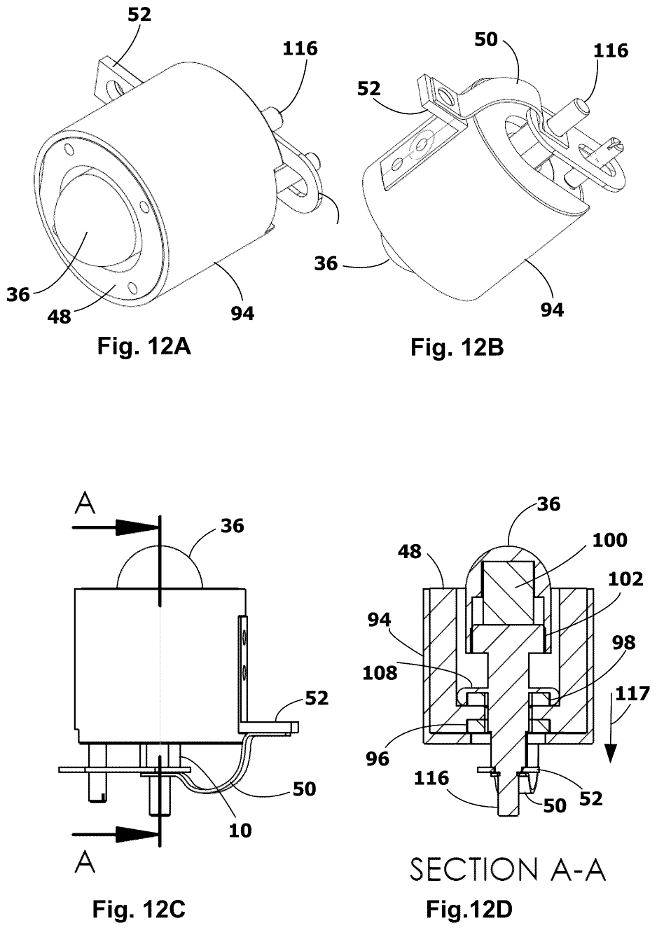

Male contact cover 102 is provided to encapsulating magnet 100 in association with conductive contact 36. From the bottom portion of cylinder element 110 extends thinner cylinder 116. The bottom portion of cylinder 48 has a recess 111 with a hole 113 in the middle. The recess 111 is shaped such that magnet 96 can rest upon the recess 111. The magnetic force in the bottom portion of cylinder 48 is influenced by several factors for example the magnetic force of magnet 96 the material the cylinder is built from and the depth of recess 111. In accordance with the present invention magnet 98 and magnet 96 have opposite poles which cause them to attract one another and thus shaft 60 can move downwards designated by arrow 117 (referred to FIG. 12D) until magnet 295655/2 housing 108 outer surface engages with the bottom portion of cylinder 48. The attraction magnetic force between conductive contacts 36 and 38 is stronger than the magnetic force between magnets 96 and 98. In order that magnets 98 and 96 will move away from one another, shaft 60 needs to move upwards in the direction opposite to the direction of arrow 117. When contacts 36 and 38 are getting closer to one another they start to attract magnetically, the magnetic force between conductive contacts 36 and 38 becomes stronger than the magnetic force between magnets 96 and 98 which causes shaft 60 to move upwards, opposite to the direction of arrow 117 and thus conductive contacts 36 extends outwards from base surface 34. When contacts 36 and 38 are close enough the magnetic attraction between them is strong enough which causes base plates 30 and 34 to engage one another and thus causing shaft 60 to move downwards in the direction of arrow 117 while the base plates 30 and 34 are still coupled to one another due to the strong magnetic force between magnet 100 and magnet 72. Member 20 further includes electrical contacts 52 fixed for example on the outer surface of cylinder 48.

Operation: electrical power charging contact system 10 operates on the principles of magnetic attraction. To charge multiple electric charge objects (rechargeable object), for example, in a stacked configuration, in the preferred embodiment of the present invention, the female charge contacts assembly 12 and the male collector charge contacts assembly 14 are positioned in opposite sides of the electric charge object. When one rechargeable object approaches to a second rechargeable object and female charge contacts assembly 12 of one object facing the male collector charge contacts assembly 14 of a second object. When the magnetic force attraction between magnets 72 of the female charge contacts assembly 12 and the magnets 100 are stronger than the magnetic force between magnets 96 and 98, shaft 60 extends a limited movement towards the openings of base plate 34 which causes the male conductive contacts 36 to extend towards female conductive contacts 38 until base plates 30 and 34 engages one another.

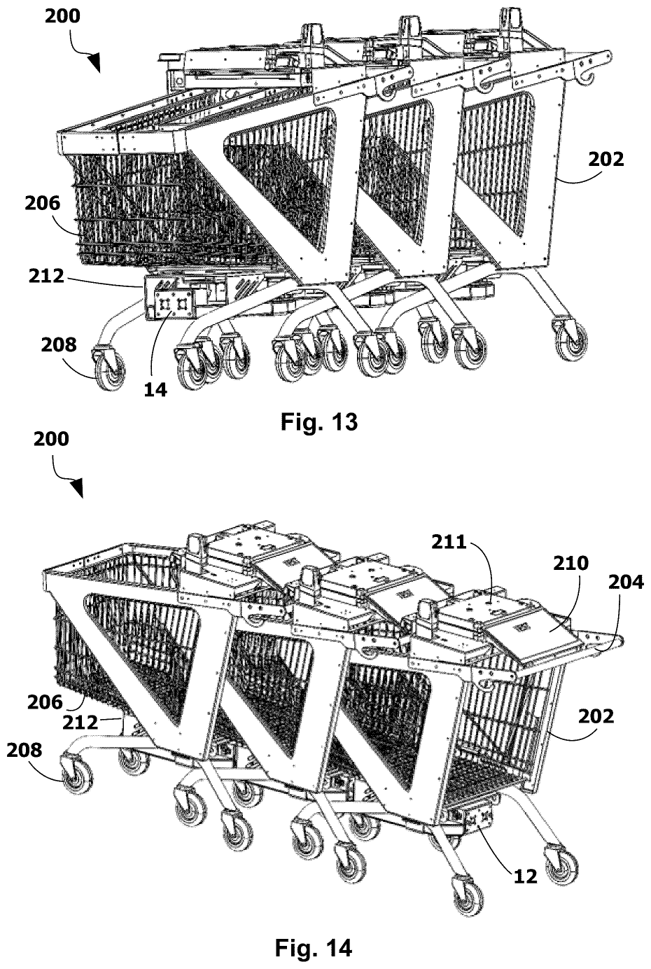

One of the benefits of the present invention is that even when plates 30 and 34 are not aligned to one another or not parallel to one another the male conductive contacts 36 and the female contact 38 can remain magnetically coupled due to the limited movement in all direction of the extendable male conductive contacts 36 which eventually, causes the plates to align to one another and to be magnetically coupled to one another. During the coupling between the male conductive contacts 36 and female conductive contacts 38 the rechargeable batteries of the rechargeable objects can be charged. To disengage between the two plates 34 and 30 a sufficient external forceis needed to overcome the attraction power of magnets 100 and 72 for example, by manually pulling the objects away from one another with sufficient power that overcomes, the attraction magnetic power between magnets 100 and magnet 72. The disengagement between the two assemblies 12 and 14 gradually reduces the magnetic power between them until no magnetic power between them when the assembly 12 of one object and assembly 14 of second object are in sufficient distance between them. When the magnetic power between the two assemblies is weaker than the magnetic power attraction between the magnets 96 and 98 shaft 60 is retracted towards magnet 96. Referring to FIG. 13 and FIG. 14, are respectively a perspective front and rear view of a row of stacked smart shopping carts 200 in accordance with some embodiments of the present invention. The objects in this example are the row of stacked smart shopping carts 200. Each shopping cart (object) 202 includes a handle 204 for pulling or pushing the cart, a basket 206 for storing items and wheels 208. The smart shopping cart may also include a monitor 210, a computer 212 with internet connectivity and optionally motors, not shown and artificial intelligent (AI) camera, not shown, for activating the wheels if the cart is working on autonomous mode. At the bottom portion of the cart, for example, attached a chargeable battery unit 212 that includes inside for example the rechargeable batteries for supplying power to the electrical devices of the cart such as but not limited to the monitor 210 and the computer 211. The chargeable battery unit 212 may also include a battery management system (BMS), not shown. In the rear and front portion of the chargeable battery unit installed the electrical power charging contact system of the invention. For example, the female charge contacts assembly 12 is installed in the rear portion of the chargeable battery unit and the male collector charge contacts assembly 14 is installed in the front portion of the chargeable battery unit 212. When the shopping carts 200 are arranged in a row stacked manner as shown for example in FIG. 13 all the chargeable battery units 212 are electrically connected to one another due to the magnetic attraction and the conductive contacts of charge contacts assembly 12 and of male collector charge contacts assembly 14. The contacts of one of the assemblies 12 or 14 can be electrically connected to a charger, not shown to charge the chargeable batteries of the chargeable battery units. To overcome the magnetic force at the conductive contacts a user can simply pull the cart 202 by using the handle to pull the cart 202 away from the next cart in the row and release the first or last cart 202 in the row.

Referring to FIG. 15 there is shown a schematic block diagram of electrical power management system 250 for charging and monitoring the charging batteries of one or more chargeable objects 252 in accordance with some embodiments of the present invention. Each chargeable object 252 includes rechargeable battery 254, the female charge contacts assembly 12 and the male collector charge contacts assembly 14. When charging the chargeable object male conductive contact 36 is attracted and coupled to the female conductive contact 38 and at least one of the chargeable objects is electrically connected to a charger 260 for charging all the rechargeable batteries 254 of all objects 252. Each of the rechargeable objects 252 may also be electrically connected to a sensor means 262 for sensing the electric charging status of each chargeable object 252 for example but not limited to a current sensor. The electrical power management system 250 further includes a controller 266 having a communication network access such as but not limited to WIFI, Bluetooth (BT) and cellular. Controller 266 collects the sensors information from all sensors 262 and can send the information for monitoring and analysis through a 295655/3 communication network 267 such as but not limited to the Internet and cellular communication networks to a computer device 268 or a database server 270.

It should be noted that one or more of the magnets described hereinabove in the embodiments of the present invention can be replaced by electromagnets or by using springs arrangement or any other known means in the art to provide the same attraction forces for achieving the same functionality of the magnets in the invention.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. An electrical power charging contacts comprising:
a female charge contact(s) assembly having at least one female conductive contact member and a first base plate connected to said at least one female conductive contact member having at least one female conductive contact;
a male collector charge contact(s) assembly having at least one male extendable conductive contact member having at least one male conductive contact, a conductive contact shaft having a magnet ring housing; said male collector charge contact(s) assembly further comprising a second base plate having at least one hole were said at least one male extendable conductive contact member is extendable therefrom;
wherein each of said male extendable conductive contact member is extendable from said second plate independently and moveable in all directions; and each of said male and female conductive contact is provided with attraction force that attracts said male and female conductive contact members when said female conductive contact is in proximity with said male conductive contact.

2. An electrical power charging contacts according to claim 1 wherein, said male extendable contact member further comprising male conductive contact shaft; said first plate has at least one opening where said at least one female conductive contact is affixed to said at least one opening; said at least one female conductive contact and said at least one extendable conductive male contact is magnetized by magnets of opposite magnetic poles for allowing them to attract to one another when they are in proximity to one another.

3. An electrical power charging contacts according to claim 2, wherein said at least one female conductive contact has a concaved surface shape and the front portion of said at least one male extendable contact has a convex surface shape.

4. An electrical power charging contacts according to claim 3 wherein the magnetic properties of said at least one female and male conductive contacts and their shapes are configured to create a magnetic ball-like joint.

5. An electrical power charging contacts according to claim 1 wherein, said at least one female charge contact(s) assembly is installed on a chargeable object having rechargeable batteries and said at least one male collector charge contact(s) assembly is also installed on said chargeable object.

6. An electrical power charging contacts according to claim 1 wherein, said at least one female charge contact(s) assembly is installed on a chargeable object having and said at least one male collector charge contact(s) assembly is installed on another chargeable object having rechargeable batteries.

7. An electrical power charging contacts according to claim 1 wherein, said at least one female charge contact(s) assembly is installed on a floor, a wall, or a ceiling.

8. An electrical power charging contacts according to claim 1 wherein, said chargeable object is selected from a group of electric devices, apparatuses, electric vehicles, or robots that can operate autonomously or non-autonomously.

9. An electrical power charging contacts according to claim 1 wherein, at least one of said base plate comprising a shock absorbing means for absorbing the impact between said two plates when they are attracted to one another.

10. An electrical power charging contacts according to claim 2 wherein, said at least one male extendable contact member is further comprising, a hollow cylinder connected perpendicular to said second plate and centrally aligned to said plate hole(s), a flexible conductive cable connected in one end to a fixed electrical contact that is fixed to said cylinder, the other end of said flexible conductive cable is connected to said male conductive contact shaft;
said at least one male extendable contact member further comprising: a cylinder magnet holder in the bottom portion of said hollow cylinder; a shaft magnet holder in the middle portion of said shaft;
first and second opposite poles magnets, where said first magnet is positioned in said cylinder magnet holder and said second magnet is positioned in said shaft magnet holder
wherein, said first and second opposite poles magnets are attracted to one another if their attraction force between them is higher than the attraction force between said conductive contact(s) of said female and male conductive contact(s) members;
thereby, said shaft is attracted to said hollow cylinder,
wherein, said first and second opposite poles magnets are moving away from each other when applying force higher than attraction force of said first and second magnet;
thereby, said shaft is moving away from the bottom portion of said hollow cylinder and said male conductive contact extends from said holes of said second plate.

11. An electrical power charging contacts according to claim 2 wherein said shaft magnet holder have rounded edge, for allowing said shaft to pivotally move inside said hollow cylinder in all directions in a limited angle.

12. An electrical power charging contacts according to claim 2 wherein, said at least one extendable conductive contact member comprising a stopper for preventing said shaft to roll.

13. An electrical power charging contacts according to claim 10 wherein said at least one female contact member further comprises nonconductive holder housing for wrapping said holder with nonconductive material, said holder housing has at least one opening for connecting electrical wires in one end to said holder electrical contact and in the other end to a power battery charger outlet; said at least one male contact member further comprising nonconductive cylinder housing.

14. An electrical power charging contacts according to claim 1, wherein said at least one extendable male conductive contact and said at least one conductive contact of said female charge contact(s) assembly are attached to high energy first and second magnets having opposite magnetic poles to attract said first and second plates to one another;
thereby, providing electrical contact between said male and female conductive contact members.

15. An electrical power charging contacts according to claim 5, wherein said objects are connected in a row stacked configuration for recharging said rechargeable batteries of said objects.

16. An electrical power charging contacts according to claim 15, wherein the charging status and charging data of said rechargeable batteries of said objects are monitored and analyzed.

17. An electrical power charging contacts according to claim 1 wherein, at lease one of said magnets are replaceable by electromagnets or by using springs arrangement or any other known means in the art to provide the same attraction forces for achieving the same functionality of said at least one magnet in the invention.
